(19) United States
(12) Patent Application Publication
(10) Pub. No.: US 2003/0200912 A1
(43) Pub. Date: Oct. 30, 2003

(54) Golf flag pin retrieval device

(76) Inventor: H. P. Brock JR., Lexington, KY (US)

Correspondence Address: Richard C. Litman, LITMAN LAW OFFICES, LTD., P.O. Box 15035, Arlington, VA, 22215, US

(21) Appl. No.: 10/218,633

(22) Filed: Aug. 15, 2002

Related U.S. Application Data
(60) Provisional application No. 60/312,488, filed on Aug. 16, 2001.

(51) Int. Cl. G09F 17/00

(52) U.S. Cl. 116/173

(57) ABSTRACT

A golf flag pin retrieval device is a wheel, preferably made of plastic, that is threaded to the top of a golf flag pin. The wheel is of such diameter that a putter head may be placed under the pin adjacent in the gap made between the ground and the wheel. The upper end of the golf flag pin may then be easily lifted up by lifting the club until the upper portion of the pin may be grasped by the golfer. The wheel has a hub having threaded taps of two sizes through opposing hub faces to allow the screwing on of the wheel device to either of two standard threaded golf flag pins. The retrieval device replaces the cap nut which is commonly used to retain the flag to the pin.

### CROSS-REFERENCE TO RELATED APPLICATION

This application claims the benefit of U.S. Provisional patent application Ser. No. ______ (unassigned), filed Aug. 16, 2001.

### BACKGROUND OF THE INVENTION

1. Field of the Invention

The present invention relates to golf flag pins. More particularly, the present invention relates to a golf pin retrieval device consisting of a plastic wheel attached to the top of the golf pin creating a gap to allow the pin to be lifted by a putter.

2. Description of the Related Art

In the game of golf, the golf flag pin is generally removed from the cup while putting. The golf flag pin is generally lay on the ground, resulting in the golfer having to bend over to pick it up in order to return it to the hole in an erect position. It would be desirable to have an attachment to the pin which would allow the golfer to lift the upper end of the pin with a putter head without bending over. This would eliminate strain on the back and speed up play. It would also be desirable to have such a device which may be easily installed on a current standard golf flag pin.

U.S. Pat. No. 1,807,089, issued May 26, 1931, to Parsons et al. describes a golf pin having colored vanes emanating from the upper end of the pin to take the place of a flag. There is a circumferential ring mounted to the vanes at their extreme ends to protect the turf when the pin is laid on the ground. The '089 patent is a complicated structure which deviates dramatically from the standard golf flag pin and is unusable with a standard golf flag pin.

U.S. Pat. No. 1,829,283, on Oct. 27, 1929, to Kip describes a golf cup having a hole pin with a spoked wheel device at the bottom end that is inserted into the cup with the pin. This device is intended for use on a practice green and is not amenable to easy uprighting of the pin since the wheel is mounted on the bottom end of the pin.

U.S. Pat. No. 3,310,026, issued Mar. 21, 1967, to Baird, Jr. describes a golf flag pin retriever having a retrieval device in the form of a spherical cage placed at the top of the flagpole. The spherical cage is constructed of a number of flexible, rod-like members connected to an anchor ring at one end and forming a tubular attachment element at the other end. In another embodiment there is shown a ring attached to the lower end of the flag pin. In the first embodiment, different devices are required for each size of a threaded pin. Also, the device is prominent to view, unsightly, and subject to breakage. The other embodiment is placed at the lower end of the flag pin and as such assists in lifting the wrong end of the pin, requiring juggling by the golfer. This embodiment is placed in the cup, and is subject to wear or breakage, and may interfere with the golf ball remaining in the cup.

U.S. Pat. No. 4,905,624, issued Mar. 6, 1990, to Krolzic describes a flag pin position indicator to inform golfers as to the depth of the pin on the putting green. The indicator is a one-piece molded part in the shape of a globe of a color and size so as to be easily seen by a golfer before he strokes his approach shot and includes a hinge and a latch for shifting along the body of the pin. The indicator of the '624 patent could be useful in retrieving a grounded pin when it is located near the flag, but would otherwise not serve that purpose. The indicator is constructed specifically to be visible from a relatively long distance and not amenable to movement to a location on the pin near the flag and movement back to the original position by each golfing party. The indicator of the '624 patent, then, would detract from the overall appearance of the course.

U.S. Pat. No. 6,029,599, issued Feb. 29, 2000, to Hiltner, Jr. describes a golf flag pin stand attached to the body of the pin near the flag by a bracket, and having legs which swing out from the golf pin to support the upper end to allow easy retrieval and serving as a rest for a golf club. The '599 patent is cumbersome and subject to breakage as well as unsightly.

None of the above inventions and patents, taken either singularly or in combination, is seen to describe the instant invention as claimed. Thus, a golf flag pin retrieval device solving the aforementioned problems is desired.

### SUMMARY OF THE INVENTION

Accordingly, it is a principal object of the invention to provide a device allowing the easy lifting of a golf flag pin from the ground.

It is another object of the invention to provide a device as above which allows the golf flag pin to be lifted by the head of a putter or other golf club.

It is a further object of the invention to provide a device as above which spaces the upper end of the golf flag pin from the ground to allow a putter head to be inserted between the pin and the ground.

Still another object of the invention is to provide a device as above which attaches to the upper end of a standard golf club pin and is not prominent to the viewer so as to detract from the appearance of the golf course.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

The present invention is a golf flag pin retrieval device which enables the easy retrieval of the flag pin from the ground for replacement in the golf cup after completion of putting. The retrieval device is a wheel, preferably made of plastic, that is threaded to the top of a golf flag pin. The wheel is of such a diameter that a putter head may be placed under the pin adjacent in the gap made between the ground and the wheel. The upper end of the golf flag pin may then be easily lifted up by lifting the club until the upper portion of the pin may be grasped by the golfer. The wheel has a hub having threaded taps of two sizes through opposing hub faces to allow the screwing on of the wheel device to either of two standard threaded golf flag pins. The device replaces the cap nut which is commonly used to retain the flag to the pin. This device is unobtrusive and has no moving or protruding parts while easing the task of bending over to pick up the pin.

FIG. 1 is an environmental, perspective view of a golf flag pin retrieval device according to the present invention.

FIG. 2 is an environmental, perspective view of a golf flag pin retrieval device as in FIG. 1 with a golf club inserted underneath the pin for retrieval.

FIG. 3 is an environmental, perspective view of a golf flag pin retrieval device as in FIG. 1 showing the golf club lifting the pin.

FIG. 4 is an environmental view of the flag pin device of the present invention as installed on a flag pin standing in a golf hole.

FIG. 5 is a plan view of the flag pin retrieval device according to the present invention.

FIG. 6 is a side view of the flag pin retrieval device of FIG. 5.

Similar reference characters denote corresponding features consistently throughout the attached drawings.

### DETAILED DESCRIPTION OF THE PREFERRED EMBODIMENT

The present invention is a golf flag pin retrieval device which enables the easy retrieval of the flag pin from the ground for replacement in the golf cup after completion of putting. The retrieval device is a wheel, preferably made of plastic, that is threaded to the top of a golf flag pin. The wheel is of such a diameter that a putter head may be placed under the pin adjacent in the gap made between the ground and the wheel. The upper end of the golf flag pin may then be easily lifted up by lifting the club until the upper portion of the pin may be grasped by the golfer. The wheel has a hub having threaded taps of two sizes through opposing hub faces to allow the screwing on of the wheel device to either of two standard threaded golf flag pins. The device replaces the cap nut which is commonly used to retain the flag to the pin. This device is unobtrusive and has no moving or protruding parts while easing the task of bending over to pick up the pin.

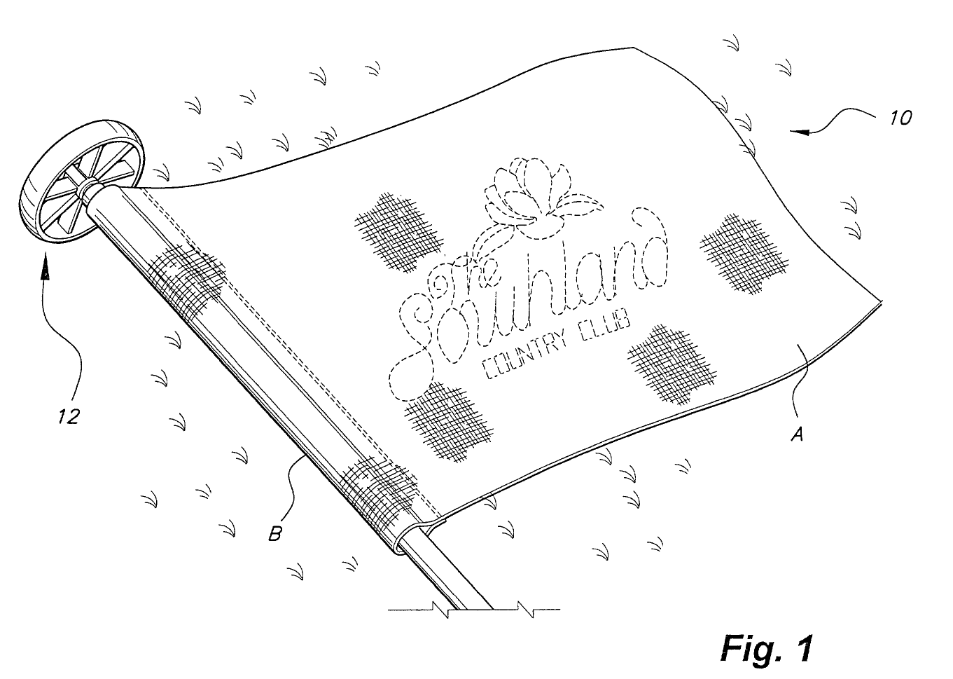

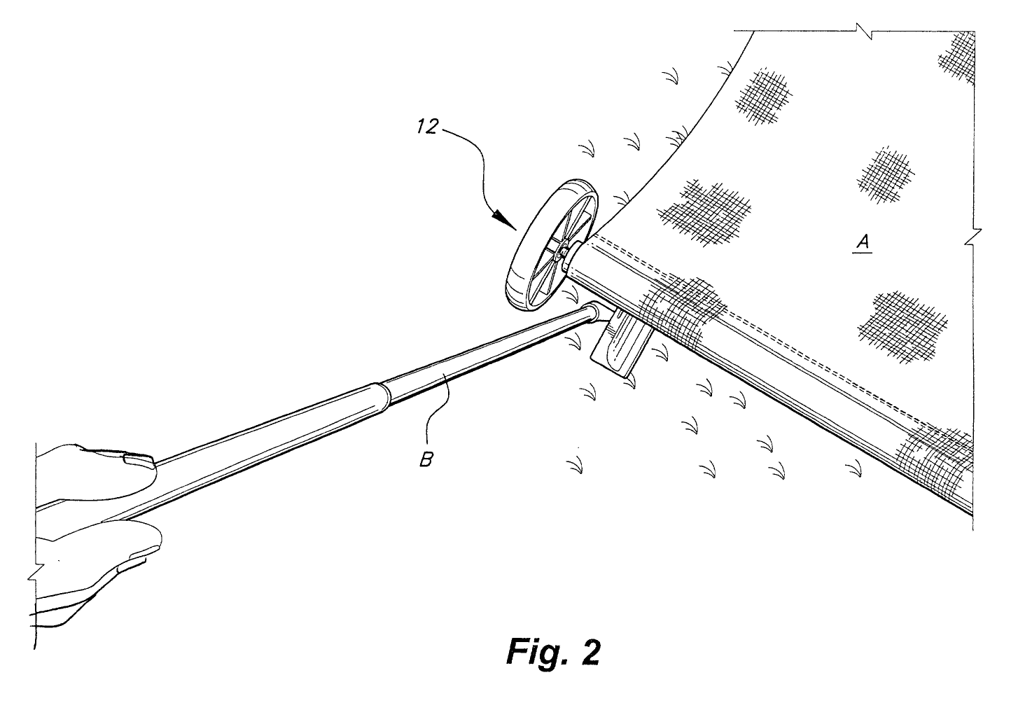

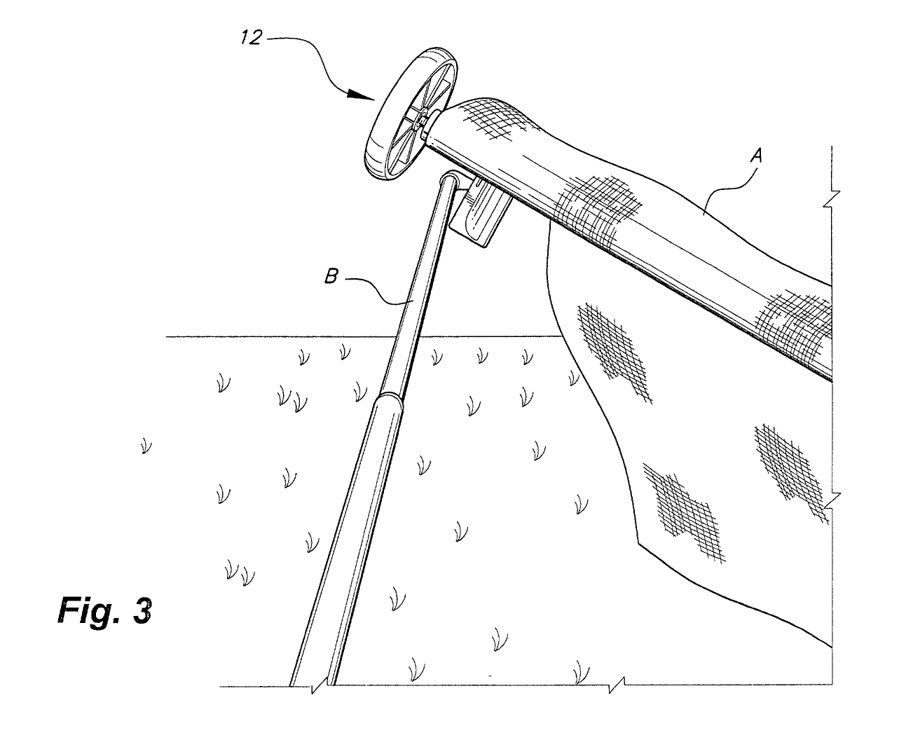

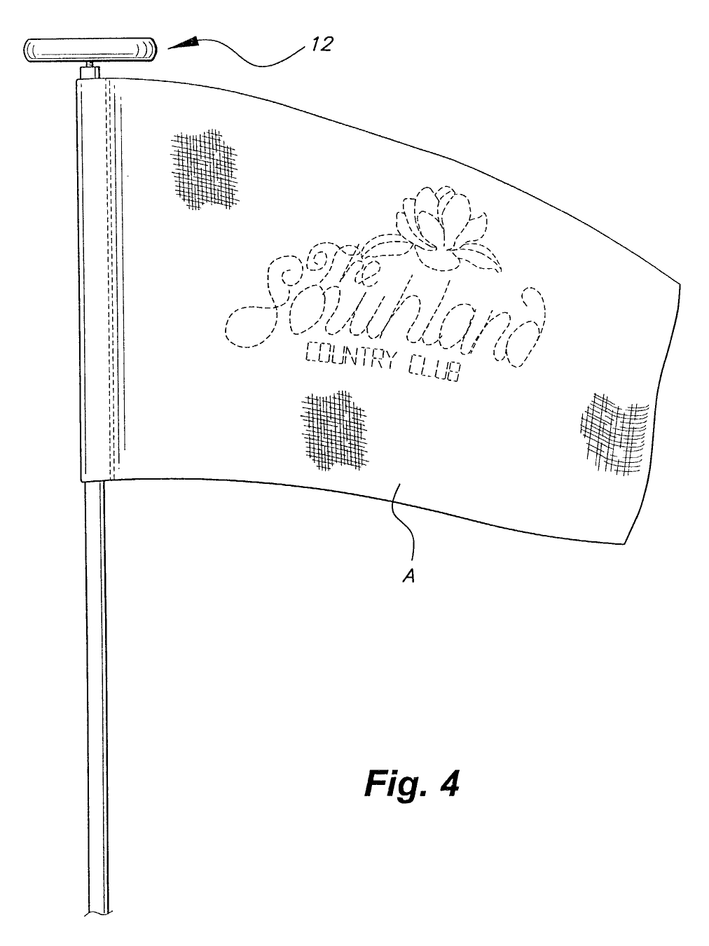

Referring to FIGS. 1-4, there are shown environmental views of the flag pin retrieval device of the present invention (1) lying on the ground, (2) with a putter head inserted underneath for retrieval, (3) with the golfer lifting the pin with the putter, and (4) as installed on a flag pin placed in a golf hole, respectively. Golf flag pin retrieval system 10 includes flag pin retrieval device 12 installed on the upper end of golf flag pin A employing putter B.

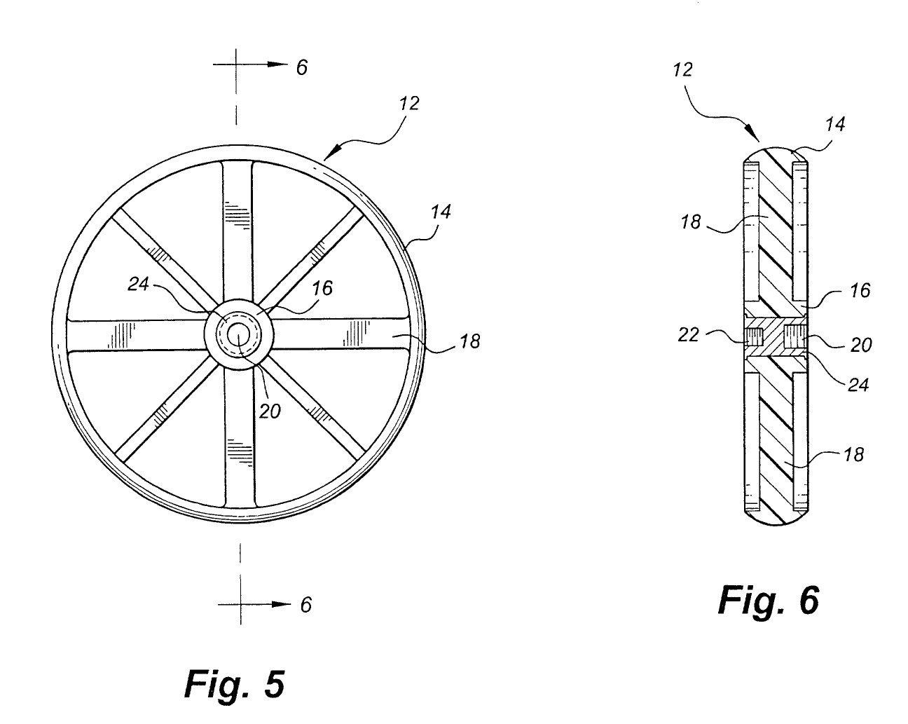

Referring to FIGS. 5 and 6, golf flag pin retrieval device 12 is generally wheel shaped, having circular peripheral rim 14 attached to centrally located hub 16 by eight spokes 18 equally spaced around hub 16. As seen in FIG. 6, hub 16 has a first tapped bore 20 having a first sized thread along its wall, and a second tapped bore 22 having a second sized thread along its wall, centrally and axially located through opposing faces of the hub 16. In one embodiment, centrally located hub 16 has a cylindrical metal insert 24 along its central axis which contains the tapped bores 20 and 22, to add to the durability of the inventive device, particularly under frequent installation and removal from the flag pin for purposes of changing flags.

The device 12 is preferably about 3½ to 4 inches in diameter, and the outer rim 12 and inner hub 16 being about 1 inch in thickness. The spokes are preferably about ¼ inch in square cross section and the hub is about 1 inch in diameter. Tapped bore 20 is preferably ⅜ inch by 16 per inch thread count. Tapped bore 22 is preferably ¼ inch by 20 per inch thread count. The device 12 is screwed onto the upper end of a standard golf flag pin A taking the place of a cap nut now universally used to allow replacement of the flag.

In use, the head of putter B is placed under the pin A near flag pin retrieval device 12 and then lifted by the golfer by means of lifting the putter B by its handle. The flag pin is lifted to the point that its upper end may be easily grasped by the golfer without his bending over.

It is to be understood that the present invention is not limited to the embodiment described above, but encompasses any and all embodiments within the scope of the following claims.

I claim:

1. A device for golf flag pin retrieval comprising;
a) means for spacing the upper end of said pin from the ground when said flag pin is resting generally horizontally on the ground, said means for spacing being generally planar and comprising:
1) a central hub having two faces;
2) an outer peripheral portion having a substantially uniform thickness; and
3) means connecting said central hub to said outer peripheral portion; and
b) means for attaching said device generally normal to said flag stick pin;
c) said peripheral portion being of such dimensions as to provide adequate space for a vertically disposed putter head to be inserted between said flag pin upper end and the ground upon which said pin rests.

2. The flag pin retrieval device of claim 1, wherein said means connecting said central hub to said outer peripheral portion comprises a plurality of spokes spaced around said hub and extending between said central hub and said peripheral portion.

3. The flag pin retrieval device of claim 1, wherein said peripheral portion has a generally circular rim shape.

4. The flag pin retrieval device of claim 2, wherein said peripheral portion has a generally circular rim shape.

5. The flag pin retrieval device of claim 1, wherein said attachment means is a threaded bore centrally located through at least one face of said hub so configured as to receive the threaded upper end of a standard golf flag pin.

6. The flag pin retrieval device of claim 5, wherein said attachment means comprises first and second threaded bores centrally located through one of each of said hub faces, each said bores being so configured as to receive the threaded end of one of two standard golf flag pins.

7. The flag pin retrieval device of claim 6, wherein said means connecting said central hub to said outer peripheral portion comprises a plurality of spokes spaced around said hub and extending between said central hub and said peripheral portion.

8. The flag pin retrieval device of claim 7, wherein said peripheral portion has a generally circular rim shape.

9. The flag pin retrieval device of claim 8, wherein said peripheral portion is from about 3½ inches to about 4 inches in diameter.

10. The flag pin retrieval device of claim 9, wherein said first of said bores is ⅜ inch in diameter by 16 threads per inch and said second of said bores is ¼ inch in diameter by 20 threads per inch.

11. The flag pin retrieval device of claim 10, wherein said hub has an axially cylindrical metal insert, said first and said second bores being axially located therein.

12. The flag pin retrieval device of claim 10 wherein both said hub and said peripheral portion are about ½ inches in thickness.

13. A golf flag pin retrieval device for attachment to the upper end of a flag pin, which is generally wheel shaped and having a central hub, an outer rim, and a plurality of spokes spaced around said central hub and connecting said hub to said outer rim, said hub having at least one centrally located and axially oriented threaded bore so configured as to engage a standard threaded upper end of a standard flag pin, said outer rim being of such diameter that when installed on said flag pin upper end, a vertically disposed golf putter head may be inserted in a gap formed between the ground and said flag pin upper end when said flag pin is placed generally horizontally on the ground.

14. The golf flag pin retrieval device of claim 13, wherein said hub has a first and a second face and a first and a second centrally located, axially oriented threaded bore is located through each said face, each said threaded bore being so sized and configured that each of said bores will receive one of two standard sized threaded flag pin upper ends.

15. The flag pin retrieval device of claim 14, wherein said first of said bores is ⅜ inch in diameter by 16 threads per inch and said second of said bores is ¼ inch in diameter by 20 threads per inch.

16. The flag pin retrieval device of claim 15, wherein said hub has an axially cylindrical metal insert, said first and said second bores being axially located therein.
